(19) United States
(12) Patent Application Publication
(10) Pub. No.: US 2026/0346266 A1
(43) Pub. Date: Nov. 5, 2026

(54) SYSTEMS AND METHODS OF WASTE DISPOSER AUTOMATIC SHUTDOWN

(71) Applicant: INSINKERATOR APPLIANCE (NANJING) CO., LTD., Nanjing, Jiangsu (CN)

(72) Inventors: Wei WU, Shaanxi (CN); Yutong ZHANG, Shaanxi (CN); Long WANG, Shaanxi (CN)

(73) Assignee: INSINKERATOR APPLIANCE (NANJING) CO., LTD., Nanjing, Jiangsu (CN)

(21) Appl. No.: 19/488,059

(22) PCT Filed: Jun. 2, 2023
(86) PCT No.: PCT/CN2023/098019

§ 371 Date: Nov. 25, 2025

(51) Int. Cl. B02C 25/00

(52) U.S. Cl. CPC B02C 25/00

(57) ABSTRACT

Waste disposer systems, controls for waste disposer systems, and methods of controlling waste disposers are provided that provide for automatic shutdown of the waste disposer when the waste has been sufficiently processed. Waste disposer systems include a waste disposer and a control system. Control systems include a motor, a sampling register, and a controller that automatically causes the motor to shut down when the control unit determines that a load variation trend of the motor is stable. Methods include the sampling register receiving parameter signals, and storing a predetermined plurality of data samples. The sampling register sends sample signals containing the predetermined plurality of data samples to the controller. The controller analyzes the predetermined plurality of data samples causes the motor to shut down when the controller determines that a load variation trend of the motor is stable.

### FIELD OF THE INVENTION

The present technology relates to waste disposers, and more particularly to systems and methods for automatic shutdown of waste disposers based on load detection.

### BACKGROUND

Waste disposers are generally used to assist in disposing of waste. Food waste disposers, in particular, are used to comminute food waste into particles small enough to safely pass through household drain plumbing. Referring to FIG. 1 (Prior Art), a conventional food waste disposer 10 may be mounted to a sink.

As shown, the food waste disposer 10 includes a food conveying section 12, a motor section 14, and a grinding section 16 disposed between the food conveying section and the motor section. The food waste disposer 10 includes a housing 18 that contains the food conveying section 12, the motor section 14, and the grinding section 16. The food conveying section 12 includes an inlet 20 for receiving food waste and water. The food conveying section 12 conveys the food waste to the grinding section 16, and the motor section 14 includes a motor imparting rotational movement to a shaft to operate the grinding section.

When used, food waste is inserted into the disposer 10, through the food conveying section 12. The food waste travels into the grinding section 16, and when the disposer 10 is powered on by a user, the grinding section 16 grinds the food waste into particles small enough to safely pass through household drain plumbing.

Most of the food waste disposers currently on the market need to be manually shut down by the user. Some food waste disposers have an automatic shutdown function, which is either controlled based on timing or a fixed load threshold.

Shutdown controlled by timing involves the disposer control system starting a timer when the food waste disposer starts to run, and automatically shutting down the disposer when the timer expires. There several problems when using shutdown controlled by timing. One is that the operation cycle is too short, resulting in the food waste disposer being shut down before the food waste has not thoroughly processed. In such circumstances, the user must restart the disposer to run at least a second operation cycle. Another is that the operation cycle is too long, resulting in the food waste disposer still running, even after the food waste has been thoroughly processed, because the shutdown time has not yet been reached. In such circumstances, there is a waste of electric energy and over-consumption of the life of the motor.

Shutdown controlled by setting a fixed load threshold involves the disposer control system monitoring the load on the motor. When the load does not reach the threshold, the control system determines that the grinding is not completed, and continues operation of the disposer. When the load reaches the threshold, the control system determines that the grinding is completed, and shuts down operation of the disposer. Although the food waste can be processed by this method, there can be issues when there is a large water flow. In such circumstances, the control system of the food waste disposer includes the water flow as part of the load, artificially inflating the amount of load and causing the disposer to continue operating unnecessarily. Such circumstances result in waste of electric energy and over-consumption of the life of the motor.

### SUMMARY

Waste disposer systems having a controller that causes automatic shutdown and methods of controlling a waste disposer to provide automatic shutdown are provided herein.

In one aspect, a waste disposer system is provided that includes a waste disposer and a control system that controls operation of the waste disposer. The waste disposer may include a food conveying section, a motor section, and a grinding section disposed between the food conveying section and the motor section. The control system includes a motor. The control system also includes a sensor that periodically takes from the motor a measurement of a parameter indicative of the load of the motor. The control system also includes a sampling register that receives data samples, each data sample relating to a measurement of the sampling sensor, and stores each data sample until the sampling register contains a predetermined number of data samples, and then sends a first sample signal including the predetermined number of data samples. The control system further includes a controller that receives the first sample signal and determines whether a load variation trend is stable based upon values of the predetermined number of data samples, and that sends a control signal that causes the motor to shut down when the controller determines that the load variation trend is stable. The motor, sensor, sampling register, and controller of the control system may all be located within the motor section.

In another aspect, a control system that controls operation of the waste disposer is provided. The control system includes a motor. The control system also includes a sensor that periodically takes from the motor a measurement of a parameter indicative of the load of the motor. The control system also includes a sampling register that receives data samples, each data sample relating to a measurement of the sampling sensor, and stores each data sample until the sampling register contains a predetermined number of data samples, and then sends a first sample signal including the predetermined number of data samples. The control system further includes a controller that receives the first sample signal and determines whether a load variation trend is stable based upon values of the predetermined number of data samples, and that sends a control signal that causes the motor to shut down when the controller determines that the load variation trend is stable.

In at least some examples, waste disposer systems and/or control systems as discussed above may include similar or identical features, and may operate in similar or identical ways. For example, the parameter that that is measured by the motor and that indicates a load of the motor may be selected from the group consisting of: motor input current, motor input voltage, back electromotive force generated by the motor, motor torque, motor speed. The sensor may send the parameter signal at predetermined time intervals, an amount of time in each predetermined time interval being about one half of a second, and wherein the predetermined number of data samples is at least eight data samples. The predetermined number of data samples may include a first data sample and a last data sample. The sampling register may update after sending the first sample signal, and the updating may include the sampling register discarding an oldest data sample, and storing a new data sample. The controller may determine whether the load variation trend is stable by calculating an average value of the data samples in the sample signal, determining a fluctuation range based on values of the data samples in the sample signal and the average value, the fluctuation range having an upper limit and a lower limit, and determining that the load variation trend is stable when all of the values of the data samples are within the fluctuation range. The upper limit may be the average value plus a range amount, and the lower limit may be the average value minus the range amount. The range amount may be selected from the group consisting of a standard deviation, a fixed percentage of a total range of values in the data samples in the sample signal, and a fixed numerical value.

In another aspect, a method is provided of controlling a waste disposer system that includes a waste disposer and a control system, the control system including a motor, a sampling register, and a control unit, to provide automatic shutdown of the waste disposer. The method initially includes determining by the control system whether the motor has been powered on. The method also includes periodically sampling by a sensor a motor parameter being measured, the motor parameter being indicative of a load of the motor, and providing data samples to the sampling register of the control system, wherein each data sample relates to a measurement of the sensor, and storing by the sampling register a predetermined number of the data samples. The method also includes determining by the control system whether the sampling register contains the predetermined number of data samples. The method additionally includes sending at least a first sample signal from the sampling register to a controller of the control unit, each sample signal including the predetermined number of data samples. The method further includes determining by the controller whether a load variation trend of the motor is stable based upon values of the predetermined number of data samples. The method finally includes sending by the controller a control signal that causes the motor to shut down when the controller determines that the load variation trend is stable.

Methods of the present technology as disused above may also include additional features. For example, sending at least a first sample signal from the sampling register to the controller may include: sending a first sample signal from the sampling register to the controller; updating the sampling register; and sending at least a subsequent sample signal from the sampling register to the controller. As another example, the predetermined number of data samples may include a first data sample and a last data sample. In such instances, updating the sampling register may include: discarding by the sampling register an oldest data sample; and storing by the sampling register a new data sample. As another example, determining by the controller whether a load variation trend of the motor is stable may include: calculating by the controller an average value of the data samples in the sample signal; determining by the controller a fluctuation range based on values of the data samples in the sample signal and the average value, the fluctuation range having an upper limit and a lower limit; and determining by the controller that the load variation trend is stable when all of the values of the data samples are within the fluctuation range.

### BRIEF DESCRIPTION OF THE DRAWINGS

Specific examples have been chosen for purposes of illustration and description, and are shown in the accompanying drawings, forming a part of the specification.

FIG. 1 is a perspective view of a Prior Art food waste disposer;

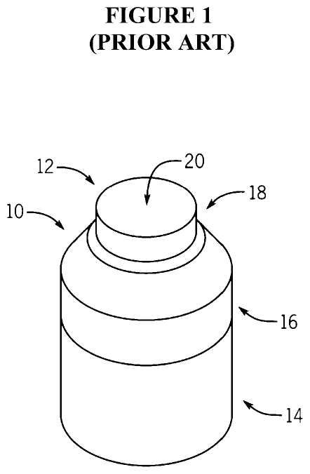

FIG. 2 is a partly cross-sectional, partly front elevation view of a waste disposer system of the present technology, mounted in relation to a sink

FIG. 3 illustrates a block diagram of a waste disposer system of FIG. 2.

FIG. 4 illustrates a method of controlling a waste disposer to provide automatic shutdown of the present technology.

While various embodiments discussed herein are amenable to modifications and alternative forms, aspects thereof have been shown by way of example in the drawings and are described in detail herein. It should be understood, however, that the disclosure is not limited to the particular embodiments described, and instead is meant to include all modifications, equivalents, and alternatives falling within the scope of the disclosure. In addition, the terms “example” and “embodiment” as used throughout this application is only by way of illustration, and not limitation, the Figures are not necessarily drawn to scale, and the use of the same reference symbols in different drawings indicates similar or identical items unless otherwise noted.

### DETAILED DESCRIPTION

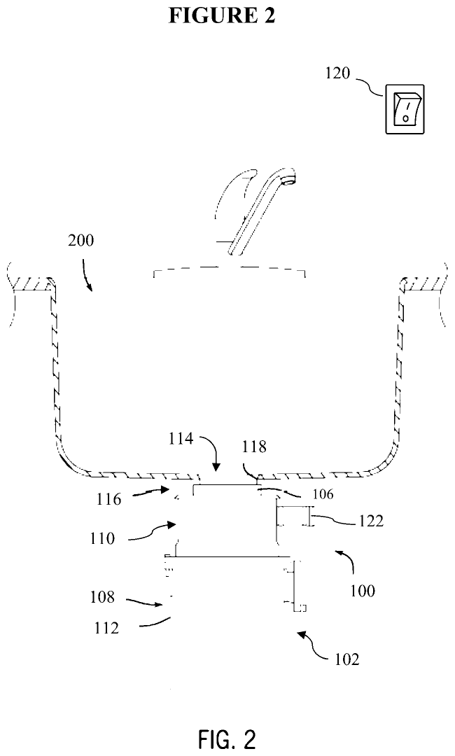

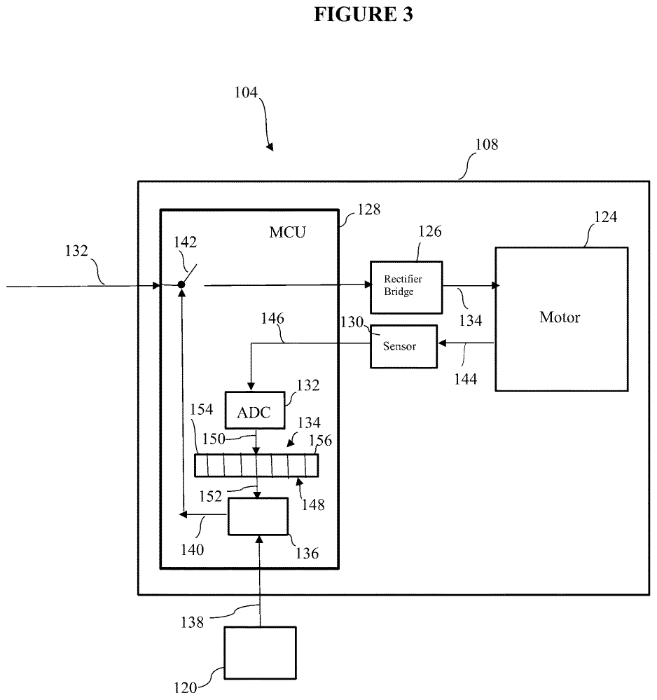

Waste disposer systems, control systems for waste disposer systems, and methods of controlling waste disposers are disclosed herein that provide for automatic shutdown of the waste disposer when the waste has been sufficiently processed. Waste disposer systems of the present technology may include a control system that controls operation of the waste disposer. The control system may cause automatic shutdown of the waste disposer when the food waste is processed, by detecting a trend relating to the load on the motor of the waste disposer, also known as a load variation trend. A load variation trend is a trend of parameters such as motor input current, motor input voltage, back electromotive force generated by the motor, motor torque, motor speed, or any other suitable parameter that indicates the load of the motor. One example of a waste disposer system 100 of the present technology is shown in FIGS. 2 and 3. The waste disposer system includes a waste disposer 102 (shown in FIGS. 2 and 3) that includes a control system 104 (shown in FIG. 3) that controls operation of the waste disposer. FIG. 2 shows the waste disposer system installed in relation to a sink 200. Although FIG. 2 shows a side elevation view of the food waste disposer 102, FIG. 2 provides a cutaway cross-sectional view of the sink 200, so as to better illustrate how the food waste disposer 102 is installed relative to the sink 200. FIG. 3 shows a block diagram of the control system 104 of the waste disposer system 100.

Referring to FIG. 2, the waste disposer system 100 includes a waste disposer 102. In the illustrated embodiment, the waste disposer 102 is a food waste disposer that is structured, designed, and configured to be installed underneath the sink 200. The waste disposer 102 may include a food conveying section 106, a motor section 108, and a grinding section 110 disposed between the food conveying 106 section and the motor section 108. The waste disposer 102 includes a housing 112 that contains the food conveying section 106, the motor section 108, and the grinding section 110. The food conveying section 106 includes an inlet 114 for receiving food waste and water. The food conveying section 106 conveys the food waste to the grinding section 110. The waste disposer 102 may be mounted to the sink 200 using a mounting assembly 116 that includes a sink flange 118. The motor section 108 includes a motor that imparts rotational movement to a shaft to operate the grinding section 110.

Waste disposer systems, generally, may use any of several types of motors, such as AC (alternating current) induction motors or permanent magnet DC (direct current) motors. Specific embodiments of the waste disposer system 100 described herein may include a permanent magnet DC motor.

When used, food waste is inserted into the disposer 102, through the inlet 114 and the food conveying section 106. The food waste travels into the grinding section 110, and when the disposer 102 is powered on by a user, using the power switch 120, the grinding section 16 grinds the food waste into particles small enough to safely pass through household drain plumbing. The ground food particles and water are then ejected into the household plumbing through the disposer outlet 122.

Referring to FIG. 3, at least most of the components of the control system 104 may be housed within the motor section 108 of the waste disposer 102. The components of the control system 104 that may be housed in the motor section 108 of the waste disposer 102 may include a motor 124, a rectifier bridge 126, a control unit 128, and a sampling sensor 130. The control unit 128 may include an analog to digital converter (ADC) unit 132, a sampling register 134, and a controller 136. The sampling register 134 may be in a random-access memory (RAM) of the controller 136.

The control system may also include the power switch 120, which a user may use to turn on the waste disposer 102, and specifically, to turn on the motor 124 of the waste disposer 102. The power switch 120 may be wired or wireless, and may be operatively connected to the motor 124. The operative connection may be direct or indirect. For example, the power switch 120 may be operatively connected to the controller 136, which is operatively connected to the motor 124. Activating the power switch 120 causes the motor 124 to start operating. In some examples, the power switch 120 may be any suitable type of switch, lever, button, or other activation mechanism. In the example shown in FIG. 2, the power switch 120 is mounted to a wall above the sink 200, within reach of a user.

As shown in FIG. 3, each of the components of the control system 104 is operatively connected to at least one other component. As used herein, the term “operatively connected” means that there is a direct or indirect connection between the two indicated components of the system, which may be wired or wireless, with each component having input and output devices as needed, in a manner that allows the transfer of power, data and/or other signals to be transferred from at least one of the components to the other component, that provides for the operation of the components and the system as described.

For example, as shown in FIG. 3, the rectifier bridge 126 is operatively connected to the motor 124, such as in a manner that the rectifier bridge 126 provides power to the motor 124. Power 132 provided from a power source (not shown), is received by the control unit 128, and is provided from the control unit 128 to the rectifier bridge 126 when the controller 136 receives a power-on signal 138 form the power switch 120. For example, when the disposer system 100 is plugged into a standard wall outlet, the control unit 128 may be activated, but power is not yet provided to the motor 124. When a user turns the switch 120 on, the switch 120 may provide a power-on signal 138 to the controller 136 of the control unit 128, and the controller 136 may send a first control signal 140 to close an actuator switch 142, thus providing power 132 from the control unit 128 to the rectifier bridge 126. In examples where the disposer system 100 is plugged into a standard wall outlet, the power 132 may be in the form of the type of current that is provided by a standard wall outlet, such as alternating current (AC). The power 132 may be converted into another form by the rectifier bridge 126 and then the converted power 134 may be provided from rectifier bridge 126 to motor 124. In some examples, the motor 124 may be a direct current (DC) motor. In such examples, the rectifier bridge may receive alternating current as power 132 and convert it into converted power 134, which may be direct current.

As shown in FIG. 3, the control system 104 may include a sampling sensor 130 that measures a parameter indicative of the load of the motor. As described above, parameters indicative of the load of the motor may be motor input current, motor input voltage, back electromotive force generated by the motor, motor torque, motor speed, or any other suitable parameter that indicates the load of the motor. The sampling senor 130 may be operatively connected to the motor 124 in a manner that the sampling sensor 130 obtains initial parameter measurements 144 from the motor 124. Each initial parameter measurement 144 contains at least one measurement of a parameter indicative of the load of the motor, and may be analog data. The sensor may be located at any suitable location within the control system 104, such as, for example, in or on the motor 124, or along the path of power being supplied to the motor 124.

During operation of the disposer, the sampling sensor 130 may periodically obtain an initial parameter measurement and send a first parameter signal 146 to the control unit 128. Periodically obtaining an initial parameter measurement 144 and sending a first parameter signal 146 may include obtaining an initial parameter measurement 144 and sending a first parameter signal 146 at predetermined time intervals, each predetermined time interval being a sampling interval. The predetermined time interval may be any suitable amount of time, such as about one second, about half of a second, or less than about half of a second. Accordingly, once the motor 124 has been turned on, the sampling sensor 130 may obtain an initial parameter measurement 144 and send a first parameter signal 146 each time the predetermined time interval elapses. Each first parameter signal 146 is a signal that includes at least one measurement taken by the sampling sensor 130 of a parameter that indicates the load of the motor 124.

The sampling sensor 130 may send each first parameter signal 146 to the control unit 128, and may send each first parameter signal 146 to an analog to digital converter (ADC) unit 132, which may be located within the control unit 128. The ADC unit 132 may periodically receive a first parameter signal 146 from the sampling sensor 130 once the motor has been turned on. The ADC unit may convert each measurement received in each first parameter signal 146 to a digital data sample 148, and may send a data signal 150 to the sampling register 134 containing each digital data sample 148. The sampling register 134 may be operatively connected to the ADC unit 132 and the controller 136. The sampling register 134 may receive each data signal 150 from the ADC unit 132 and store each data sample 148 therein. However, the sampling register 134 may have a limited capacity, and thus only be able to store up to a predetermined number of data samples 148. The sampling register 134 may also provide a sample signal 152 to the controller 136.

For example, during operation, the sampling register 134 may periodically receive each data signal 150 from the ADC unit 132 and store each data sample 148 therein, until the sampling register 134 is full, and thus contains a predetermined plurality of data samples 148. The predetermined plurality of data samples 148 may include any suitable number of data samples 148, and includes at least a first data sample 154 and a last data sample 156. In some examples, the predetermined plurality of data samples 148 may be at least two data samples, or greater than two data samples, including from two data samples to ten data samples, greater than eight data samples, greater than ten data samples, from eight to sixteen data samples, sixteen data samples, greater than sixteen data samples, from sixteen data samples to thirty-two data samples, or any other suitable number of data samples. When the sampling register 134 is full, the sampling register 134 may send a sample signal 152 to the controller 136.

Once the sampling register 134 is full, it may overwrite or replace the then oldest data sample 148 with a new data sample 148 when it receives a new data signal 150 from the ADC unit 132. The sampling register 134 may be any suitable type of register may be a first in first out (FIFO) register, and may discard the current oldest data sample 148 and replace it with the newest data sample 148 each time a new data signal 150 is received by the sampling register 134.

Once the sampling register 134 is full for the first time, the sampling register 134 is considered to be full again each time a data sample 148 is received by the sampling register 134. Accordingly, when the sampling register 134 has initially collected the predetermined plurality of data samples 148, the sampling register 134 may send a first sample signal 152 to the controller 136. The sampling register 134 may then send a subsequent sample signal 152 to the controller 136 each time a new data sample 148 is received by the sampling register 134. Each sample signal 152 may contain all of the predetermined plurality of data samples 148 in the sampling register 134 at the time that the sample signal 152 is sent. Thus, in such an example, each subsequent sample signal 152 differs from the immediately previous sample signal 152 because it contains a new last (most recent) data sample 156 and does not contain the previous first (oldest) data sample 154. In other words, if each data sample 148 is sequentially numbered as it is received by the sampling register 134, and the predetermined number of data samples is sixteen, the first sample signal 152 sent by the sampling register 134 would contain data samples one through sixteen, the second sample signal 152 sent by the sampling register 134 would contain data samples two through seventeen, the third sample signal 152 sent by the sampling register 134 would contain data samples three through eighteen, and so forth.

The control unit 128 is operatively connected to the motor 124, in a manner that the control unit 128 regulates whether power is sent to the motor 124. The control unit 128 may contain at least one processor, and at least one non-volatile memory, such as a random access memory (RAM), which may contain the sampling register 134. The functions and components of the control unit 128 as described herein may be implemented in hardware and/or software, as appropriate.

As shown in FIG. 3, the controller 136 sends control signals 140 to open or close an actuator switch 142, which regulates whether power 132 is provided to the rectifier bridge 126, and ultimately whether power is provided to the motor 124. As described above, when the user activates the power switch 120 to power the motor on, the controller 136 may send a first control signal 140 to close the actuator switch 142, thus providing power 132 from the control unit 128 to the rectifier bridge 126, which in turn provides power to the motor 124. The controller 136 also analyzes each sample signal 152 received from the sampling register 134 and determines whether to automatically shut down the motor 124, such as by sending a second control signal 140 to open the actuator switch 142 and stop providing power to the rectifier bridge 126 and the motor 124.

Without being bound by any particular theory, it is believed that the load variation trend of the motor 124 changes greatly when the disposer 102 is processing food waste, and that the load variation trend of the motor changes slowly when there is only water flow in the disposer 102. Therefore, the systems and methods of the present technology provide for the automatic shutdown of the waste disposer 102 by detecting the load variation, and determining whether the load variation trend is stable.

In order to determine whether to cause automatic shutdown of the motor 124 once it has been activated, such as by a user activating the switch 120, the controller 136 receives each sample signal 152 from the sampling register 134, and determines whether the load variation trend is stable. If the load variation trend is stable, then the controller 136 automatically sends a control signal 140 that causes the motor 124 to shut down.

In order to function as described herein, the controller 136 may contain at least one processor, and at least one non-volatile memory. The functions of the controller 136 as described herein may be implemented in hardware and/or software, as appropriate.

The controller 136 may determine whether the load variation trend is stable in any suitable manner. The load variation trend is the trend of the values of the data samples 148. In at least one example, the controller 136 may calculate an average value of the data samples 148 in the sample signal 152. The controller 136 may also calculate a fluctuation range based on the average value and the values of the data samples 148 in the sample signal 152.

The fluctuation includes an upper limit and a lower limit. The fluctuation range may be determined in any suitable manner, such as the average value of the data samples 148 in the sample signal 152 plus or minus a range amount. The upper limit may be the average value of the data samples 148 in the sample signal 152 plus the range amount. The lower limit may be the average value of the data samples 148 in the sample signal 152 minus the range amount. The range amount may be any suitable amount, such as standard deviation, a fixed percentage of the total range of values in the data samples 148 in the sample signal 152, or a fixed numerical value. Accordingly, in one example, the upper limit of the fluctuation range may be the average value of the data samples plus one standard deviation, and the lower limit of the fluctuation range may be the average value of the data samples minus one standard deviation. In another example, the upper limit of the fluctuation range may be the average value of the data samples plus a fixed percentage, such as 10%, 15%, 20% 25%, or another fixed percentage, and the lower limit of the fluctuation range may be the average value of the data samples minus the fixed percentage. In yet another example, the upper limit of the fluctuation range may be the average value of the data samples plus a fixed numerical value, such as 20, 25, 30, 50, or any other suitable fixed numerical value or another fixed numerical value, and the lower limit of the fluctuation range may be the average value of the data samples minus the fixed numerical value.

The controller 136 may compare each of the values in the data samples 148 in the sample signal 152 to the upper limit and the lower limit, and determine whether each of the values is within the fluctuation range. If any of the values in the data samples 148 in the sample signal 152 is outside of the fluctuation range, the controller 136 may determine that the load variation trend is not stable, and may allow the motor 124 to continue operation. If the controller 136 determines that load variation trend is stable is not stable for a first sample signal 152, the controller 136 may then determine whether the load variation trend is stable for each subsequent sample signal 152, until the control unit determines that the load variation trend is stable. If all of the values in the data samples 148 in any subsequent sample signal 152 are within the fluctuation range, the controller 136 may determine that the load variation trend is stable, and the controller 136 may automatically send a control signal 140 that causes the motor 124 to shut down.

### EXAMPLE

In one example, a disposer system 100 of the present technology may be provided in accordance with the discussion of FIGS. 2 and 3 provided above. Referring to FIGS. 2 and 3, the disposer system 100 may include a waste disposer 102 and a control system 104. The disposer system may be installed with respect to a sink 200. During operation of the waste disposer 102, the sensor 130 may periodically, at predetermined time intervals, take or receive from the motor 124 a measurement 144 of a parameter indicative of the load of the motor 124, and send a parameter signal 146 to the control unit 128. More specifically, the sensor 130 may periodically, at predetermined time intervals, take or receive from the motor 124 a measurement 144 of a parameter indicative of the load of the motor 124, and send a parameter signal 146 to the ADC unit 132 of the control unit 128. In this example, the predetermined time interval may be about half of a second (500 milliseconds). Accordingly, once the motor 124 has been turned on, such as by a user activating the switch 120, the sensor 130 may take a measurement 144 and send a parameter signal 146 about every half of a second. Each parameter signal 146 is a signal that includes data that relates to at least one measurement 144 of a parameter that indicates the load of the motor at the time the measurement 144 was taken. In this example, the parameter may be motor input current, and the sensor may be a shunt resistor.

The ADC unit 132 may receive each parameter signal 146. When the parameter signal includes analog data, the ADC unit may convert the analog data to digital data. The ADC unit may send a data signal 150 to the sampling register 134 containing at least one data sample 148. Each data sample 148 relates to at least one measurement 144 taken by the sensor 130, in this example, the motor input current, and is indicative of the load of the motor 124 at the time the measurement 144 was taken.

In this example, the sampling register 134 may be configured to store a finite number of data samples 148, such as sixteen data samples 148. Accordingly, once the motor 124 has been turned on, such as by a user activating the switch 120, the sampling register 134 may periodically receive and store a data sample 148 until it has received sixteen data samples 148 and is thus full. The sampling register 134 may then send a first sample signal 152 to the controller 136. The first sample signal 152 may contain all of the predetermined plurality of data samples 148 in the sampling register 134 at the time that the sample signal 152 is sent, which in this instance is the first sixteen data samples 148 received by the sampling register 134. When the sampling register 134 receives a next, newest, data sample 148, such as the seventeenth data sample 148, the sampling register 134 may update by replacing the oldest data sample 148, in this instance the first data sample 148, with the newest data sample 148. The sampling register may then send a subsequent sample signal 152 to the controller 136, which may contain all of the predetermined plurality of data samples 148 in the sampling register 134 at the time that the sample signal 152 is sent, which in this instance is the second data sample 148 through the seventeenth data sample 148 that were received by the sampling register 134.

When the controller 136 receives the first sample signal 152, the controller 136 may calculate an average value of the data samples 148 in the sample signal 152, as well as a fluctuation range, including an upper limit and a lower limit, based on the data samples 148 in the sample signal 152. The control unit may compare each of the values in the data samples 148 in the first sample signal 152 to the upper limit and the lower limit, and determine whether each of the values is within the fluctuation range. In this example, at least one of the values in the data samples 148 in the first sample signal 152 is outside of the fluctuation range. The controller 136 thus determines that the load variation trend is not stable, and allows the motor 124 to continue operation. The controller 136 then determines whether the load variation trend is stable for each subsequent sample signal 152. Once the control unit receives a subsequent sample signal for which all of the values in the data samples 148 the subsequent sample signal 152 are within the fluctuation range, the controller 136 determines that the load variation trend is stable, and the controller 136 automatically sends a control signal 140 that causes the motor 124 to shut down.

### METHODS

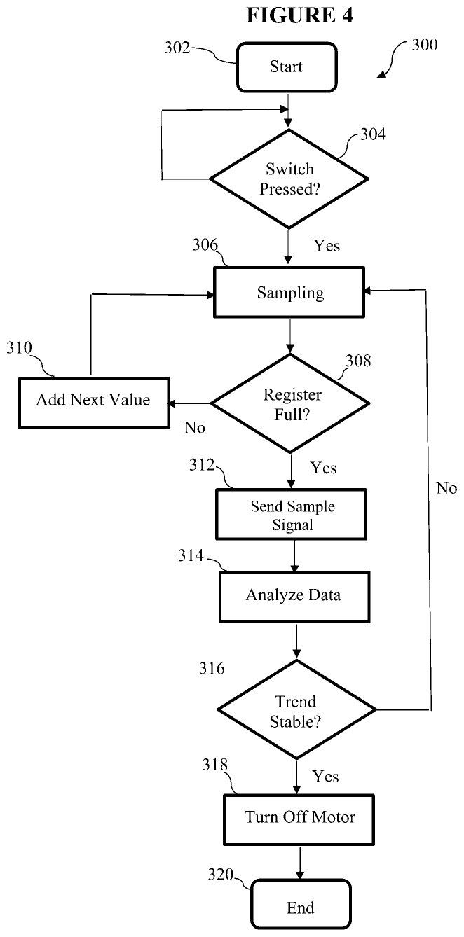

FIG. 4 illustrates one example of a method 300 of controlling a waste disposer system to provide automatic shutdown of the waste disposer in accordance with the present technology. The waste disposer system using the method may be a disposer system 100 of the present technology in accordance with the discussion of FIGS. 2 and 3 provided above, and may include a waste disposer 102 and a control system 104.

The method starts at step 302, which includes beginning the method. Beginning the method may include powering up the control board. The method may continue to step 304, which includes the control system determining whether the motor has been powered on. Referring to the example shown in FIGS. 2 and 3, the control system 104, and in particular, the controller 136 may determine whether the power switch 120 has been activated by a user, or may otherwise determine that the motor has been powered on and is operating. If the motor has not been powered on, the method may repeat step 304 until the control system 104, and in particular, the controller 136, determines that the motor 124 has been turned on. In the example illustrated in FIG. 3, step 304 may be accomplished when the controller 136 receives a power-on signal 138 from the power switch 120, and sends a control signal 140 to the switch 142 to provide power 132 through the rectifier bridge 126 to the motor, and thus determines that the motor 124 has been powered on.

Once the motor has been powered on, the method may continue to step 306, which includes sampling the motor parameter being measured. The sampling includes periodically sampling by a sensor a motor parameter being measured, the motor parameter being indicative of a load of the motor, and providing data samples sending a parameter signal from the motor to the sampling register of the control system, wherein each parameter signal includes a data sample relates to a measurement of the sensor, and storing by the sampling register a predetermined number of the data samples. The sampling thus includes the sensor periodically receiving measurements and sending parameter signals, and may include the ADC unit receiving the parameter signals and sending data signals to the sampling register that each contain at least one data sample. The sampling also includes the sampling register receiving and storing each data sample. Referring to the example shown in FIGS. 2 and 3, the sensor 130 may periodically send parameter signals 146 at predetermined time intervals. Each of the parameter signals 146 may be sent from the sensor 130 to the ADC unit 132, and may contain at least one measurement 144 received by the sensor. In at least one example where the motor parameter is motor input current, the sensor 130 may be a sampling resistor, and the analog-to-digital converter (ADC) unit 132 in the control unit 128 may periodically receive a parameter signal 146 from the sensor, convert analog information relating to the at least one measurement 144, and send a data signal 150 to the sampling register 134 containing at least one data sample 148 that relates to the at least one measurement 144 and is indicative of the load of the motor at the time the measurement 144 was taken.

Step 306 may also include the sampling register storing the data sample from each parameter signal, until the sampling register is full, and thus contains a predetermined plurality of data samples. Referring to the example shown in FIGS. 2 and 3, the sampling register 134 may store the at least one data sample 148 from each data signal 150, until the sampling register 134 is full.

Accordingly, the method may proceed to step 308, which includes the control system, and particularly the sampling register or the control unit, determining whether the sampling register is full. Referring to the example shown in FIGS. 2 and 3, the sampling register 134 may store the at least one data sample 148 from each data signal 150, until the sampling register 134 is full, and thus contains a predetermined plurality of data samples 148.

If the sampling register is not full, the method may proceed to step 310, which includes the sampling register adding the value of the next data sample from the next sample signal to the sampling register. Referring to the example shown in FIGS. 2 and 3, the sampling register 134 may store a value of the first data sample 154, and each subsequent data sample 148 up to and including the last data sample 156, and at that point, the control system 104 may determine that the sampling register 134 is full for a first time.

When the sampling register 134 is full, then the method may proceed to step 312, which includes the sampling register sending a sample signal to the control unit. Referring to the example shown in FIGS. 2 and 3, when the sampling register 134 has initially collected the predetermined plurality of data samples 148, the sampling register may send a first sample signal 152 to the controller 136. The sampling register 134 may then send a subsequent sample signal 152 to the controller 136 each time a new data signal 150 is received by the sampling register 134 and a new data sample 148 is stored. Each sample signal 152 contains all of the predetermined plurality of data samples 148 in the sampling register 134 at the time that the sample signal 152 is sent. The method may proceed to step 314, which includes the controller analyzing the data in the sample signal 152. Referring to the example shown in FIGS. 2 and 3, the controller 136 may calculate an average value of the data samples 148 in the sample signal 152, and may also calculate a fluctuation range, having an upper limit and a lower limit, based on the data samples 148 in the sample signal 152. The upper limit may be the average value plus a range amount, and the lower limit may be the average value minus the range amount. The range amount may be a fixed numerical value, or the average value multiplied by a fixed percentage.

The method may proceed to step 316, which includes the controller 136 determining whether the load variation trend is stable based on the analysis of the data in the sample signal 152. The controller 136 may compare each of the values in the data samples 148 in the sample signal 152 to the upper limit and the lower limit, and determine whether each of the values is within the fluctuation range. If any of the values in the data samples 148 in the sample signal 152 is outside of the fluctuation range, the controller 136 may determine that the load variation trend is not stable. If the load variation trend is not stable, then the method may return to step 306, and continue sampling.

When the method returns to step 306, the sampling includes updating the sampling register. Referring to the example shown in FIGS. 2 and 3, updating the sampling register 134 may include the sampling register 134 discarding the oldest data sample, which may be the first data sample 144, and storing a new data sample 148 from a new (or subsequent) sample signal 150.

If all of the values in the data samples 148 in any subsequent sample signal 152 are within the fluctuation range, the controller 136 may determine that the load variation trend is stable. If the load variation trend determined to be stable, then the method may proceed to step 318, which includes the controller 136 sending a control signal that causes the motor 124 to automatically shut down. Upon automatic shutdown of the motor, the method may end at step 320.

Systems and methods of the present technology may provide one or more advantages over currently known disposer systems and methods. For example, systems and methods of the present technology may avoid the waste disposer 102 shutting down when the food waste processing is not completed. As another example, systems and methods of the present technology may avoid the waste disposer 102 not automatically shutting down when there is only water flow and no food waste. As yet another example, systems and methods of the present technology may reduce the overall power consumption of the waste disposer, and may protect motor life while ensuring that food waste is sufficiently processed.

Systems and methods of the present technology may be implemented in any suitable manner. For example, the specific examples described herein include a control unit 128 having certain components, and describe other components as being separate from the control unit 128. However, any of the components may be implemented as separate units, or combined into a single unit, as long as they are operatively connected and configured to perform the functions described herein. For example, the sensor 130 may be on or in the motor 124, or may be connected to the control unit 128 or the rectifier bridge 126, or anywhere else within the control system 104, as appropriate to measure the desired parameter indicative of the load of the motor 124. Additionally, any of the components may be implemented using hardware, software, or a combination thereof, as appropriate. Further, although the examples discussed herein relate to a disposer system 100 and control system 104 that include a rectifier bridge 126 and a direct current (DC) motor 124, alternative examples may include a different type of motor, and may not include a rectifier bridge.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A waste disposer system comprising:
a waste disposer; and
a control system that controls operation of the waste disposer, the control system including:
a motor;
a sensor that periodically takes from the motor a measurement of a parameter indicative of the load of the motor;
a sampling register that receives data samples, each data sample relating to a measurement of the sampling sensor, and stores each data sample until the sampling register contains a predetermined number of data samples, and then sends a first sample signal including the predetermined number of data samples; and
a controller that receives the first sample signal and determines whether a load variation trend is stable based upon values of the predetermined number of data samples, and that sends a control signal that causes the motor to shut down when the controller determines that the load variation trend is stable.

2. The waste disposer system of claim 1, wherein the waste disposer includes a food conveying section, a motor section, and a grinding section disposed between the food conveying section and the motor section.

3. The waste disposer system of claim 2, wherein the motor, sensor, sampling register, and controller of the control system are located within the motor section.

4. The waste disposer system of claim 1, wherein the parameter is selected from the group consisting of: motor input current, motor input voltage, back electromotive force generated by the motor, motor torque, motor speed.

5. The waste disposer system of claim 1, wherein the sensor sends the parameter signal at predetermined time intervals, an amount of time in each predetermined time interval being about one half of a second, and wherein the predetermined number of data samples is at least 8 data samples.

6. The waste disposer system of claim 1, wherein the predetermined number of data samples includes an oldest data sample and a most recent data sample, and wherein the sampling register updates after sending the first sample signal, the updating including the sampling register discarding the oldest data sample, and storing a new data sample.

7. The waste disposer system of claim 1, wherein the controller determines whether the load variation trend is stable by calculating an average value of the data samples in the sample signal, determining a fluctuation range based on values of the data samples in the sample signal and the average value, the fluctuation range having an upper limit and a lower limit, and determining that the load variation trend is stable when all of the values of the data samples are within the fluctuation range.

8. The waste disposer system of claim 7, wherein the upper limit is the average value plus a range amount, and the lower limit is the average value minus the range amount.

9. The waste disposer system of claim 8, wherein the range amount is selected from the group consisting of a standard deviation, a fixed percentage of a total range of values in the data samples in the sample signal, and a fixed numerical value.

10. A method of controlling a waste disposer system that includes a waste disposer and a control system, the control system including a motor, a sampling register, and a controller, to provide automatic shutdown of the waste disposer, the method comprising:
determining by the control system whether the motor has been powered on;
periodically sampling by a sensor a motor parameter being measured, the motor parameter being indicative of a load of the motor, and providing data samples to the sampling register of the control system, wherein each data sample relates to a measurement of the sensor, and storing by the sampling register a predetermined number of the data samples;
determining by the control system whether the sampling register contains the predetermined number of data samples;
sending at least a first sample signal from the sampling register to the controller, each sample signal including the predetermined number of data samples;
determining by the controller whether a load variation trend of the motor is stable based upon values of the predetermined number of data samples; and
sending by the controller a control signal that causes the motor to shut down when the controller unit determines that the load variation trend is stable.

11. The method of claim 10, wherein sending at least a first sample signal from the sampling register to the controller includes:
sending a first sample signal from the sampling register to the controller;
updating the sampling register; and
sending at least a subsequent sample signal from the sampling register to the controller.

12. The method of claim 11, wherein the predetermined number of data samples includes an oldest data sample and a most recent data sample, and wherein updating the sampling register includes:
discarding by the sampling register the oldest data sample;
and
storing by the sampling register a new data sample.

13. The method of claim 10, wherein determining by the controller whether a load variation trend of the motor is stable includes:
calculating by the controller an average value of the data samples in the sample signal;
determining by the controller a fluctuation range based on values of the data samples in the sample signal and the average value, the fluctuation range having an upper limit and a lower limit; and
determining by the controller that the load variation trend is stable when all of the values of the data samples are within the fluctuation range.

14. A control system that controls operation of the waste disposer, the control system comprising:
a motor;
a sensor that periodically takes from the motor a measurement of a parameter indicative of the load of the motor;
a sampling register that receives data samples, each data sample relating to a measurement of the sampling sensor, and stores each data sample until the sampling register contains a predetermined number of data samples, and then sends a first sample signal including the predetermined number of data samples; and
a controller that receives the first sample signal and determines whether a load variation trend is stable based upon values of the predetermined number of data samples, and that sends a control signal that causes the motor to shut down when the controller determines that the load variation trend is stable.

15. The control system of claim 14, wherein the parameter is selected from the group consisting of: motor input current, motor input voltage, back electromotive force generated by the motor, motor torque, motor speed.

16. The control system of claim 14, wherein the sensor sends the parameter signal at predetermined time intervals, an amount of time in each predetermined time interval being about one half of a second, and wherein the predetermined number of data samples is at least 8 data samples.

17. The control system of claim 14, wherein the predetermined number of data samples includes an oldest data sample and a most recent data sample, and wherein the sampling register updates after sending the first sample signal, the updating including the sampling register discarding the oldest data sample, and storing a new data sample.

18. The control system of claim 14, wherein the controller determines whether the load variation trend is stable by calculating an average value of the data samples in the sample signal, determining a fluctuation range based on values of the data samples in the sample signal and the average value, the fluctuation range having an upper limit and a lower limit, and determining that the load variation trend is stable when all of the values of the data samples are within the fluctuation range.

19. The control system of claim 18, wherein the upper limit is the average value plus a range amount, and the lower limit is the average value minus the range amount.

20. The control system of claim 19, wherein the range amount is selected from the group consisting of a standard deviation, a fixed percentage of a total range of values in the data samples in the sample signal, and a fixed numerical value.
